(19) United States
(12) Patent Application Publication
(10) Pub. No.: US 2022/0009803 A1
(43) Pub. Date: Jan. 13, 2022

(54) SOIL AND WATER QUALITY IMPROVEMENT METHOD

(71) Applicant: TRUE TEN INDUSTRIAL CO., LTD., Taichung City (TW)

(72) Inventors: Shun-Tsung LU, Taichung City (TW); Ta-Wei LU, Taichung City (TW)

(21) Appl. No.: 16/927,916

(22) Filed: Jul. 13, 2020

(51) Int. Cl. C02F 1/461; C02F 1/78

(52) U.S. Cl. CPC C02F 1/46109; C02F 1/78; C05F 11/00; C02F 2305/023; C02F 2201/784; C02F 2001/46171

(57) ABSTRACT

A soil and water quality improvement method includes the following steps. An electrode element is disposed into a tubular body and he tubular body includes a plurality of through holes formed therein. The tubular body is then buried in a growing medium to be improved. Afterwards, ozone water is introduced into the tubular body and the ozone water is spread through the through holes into the growing medium to carry out an operation of sterilizing, and then electricity is conducted into the electrode element to carry out electrolysis. After the operations, an inspecting element is used to inspect the growing medium. Finally, the nutrition additive is conducted into the growing medium through the tubular body to complete the improvement of the growing medium, allowing a contaminated growing medium to be reused for cultivation.

### TECHNICAL FIELD OF THE INVENTION

The present invention relates to a soil and water quality improvement method, and more particularly to a soil and water quality improvement method that improves soil or liquid water that have been contaminated.

### DESCRIPTION OF THE PRIOR ART

Agriculture has been the most significant and the most important economic activity of human beings, and plays a necessary role of human living. Particularly, agriculture has always been the primary food source of food for Chinses.

Agriculture is an economic activity of growing edible or processable plants and then harvesting the plants that get mature to serve as food, fabric, fuel, or medicine. However, most of the agricultural products are grown in soil, although some are planted in water of liquid form. Both ways of agriculture are advantageous of being stable, as compared to benefits from other types of farming, such as animal husbandry and pastoralism, and could support the necessity of living for most people, unless catastrophic natural or human disasters.

With the change of times, a lot of ground has been overused in the present day, and suffers insufficiency of nutrition, or the progress of industry brings the generation of a large amount of waste objects and waste water, leading to contamination or pollution of a large amount of soil and water resources, preventing such contaminated soil and water sources from being used in growing agricultural products or any other ways.

### SUMMARY OF THE INVENTION

The primary objective of the present invention is to improve soil or water quality by means of ozone water and electrolysis, in order to make contaminated soil or water resources reusable.

To achieve the above objective, the present invention includes the following main steps: firstly disposing an electrode element in an interior of a tubular body, and forming a plurality of through holes in the tubular body; then, burying the tubular body in a growing medium to be improved, and first introducing ozone water into the interior of the tubular body to allow the ozone water to enter the growing medium through each of the through holes to carry out an operation of sterilizing and then conducting electricity into the electrode element to remove harmful substances contained in the growing medium through electrolysis; and after completion of improvement, applying an inspecting element to inspect the condition of the growing medium and introducing a necessary nutrition additive into the tubular body for uniformly spreading, by way of the through holes, in the growing medium, and as such, a user is allowed to make cultivation of agricultural plants in the growing medium.

With the above steps, the tubular body is directly buried or installed in soil or water resources to be improved, providing an easy and convenient way of use or operation. Afterwards, ozone water and electrolysis are applied to remove harmful substances from the growing medium to thereby achieve a result of completely improving and cleaning the growing medium.

With the above-discussed technique, the problem that contaminated soil or water resource being not reusable can be overcome to achieve practical improvement for the above advantage.

### BRIEF DESCRIPTION OF THE DRAWINGS

FIG. 1 is a perspective view showing a preferred embodiment of the present invention.

FIG. 2 is a flow chart illustrating steps of a process according to the preferred embodiment of the present invention.

FIG. 3 is a schematic view showing burying according to the preferred embodiment of the present invention.

FIG. 4 is a schematic view showing sterilizing according the preferred embodiment of the present invention.

FIG. 5 is a schematic view showing electrolyzing according to the preferred embodiment of the present invention.

FIG. 6 is a schematic view showing inspecting according to the preferred embodiment of the present invention.

FIG. 7 is a schematic view showing fertilizing according to the preferred embodiment of the present invention.

FIG. 8 is a flow chart illustrating steps of a process according to another preferred embodiment of the present invention.

FIG. 9 is a schematic view showing timed electrolyzing according to said another embodiment of the present invention.

FIG. 10 is a schematic view showing planting according to a further embodiment of the present invention.

### DETAILED DESCRIPTION OF THE PREFERRED EMBODIMENT

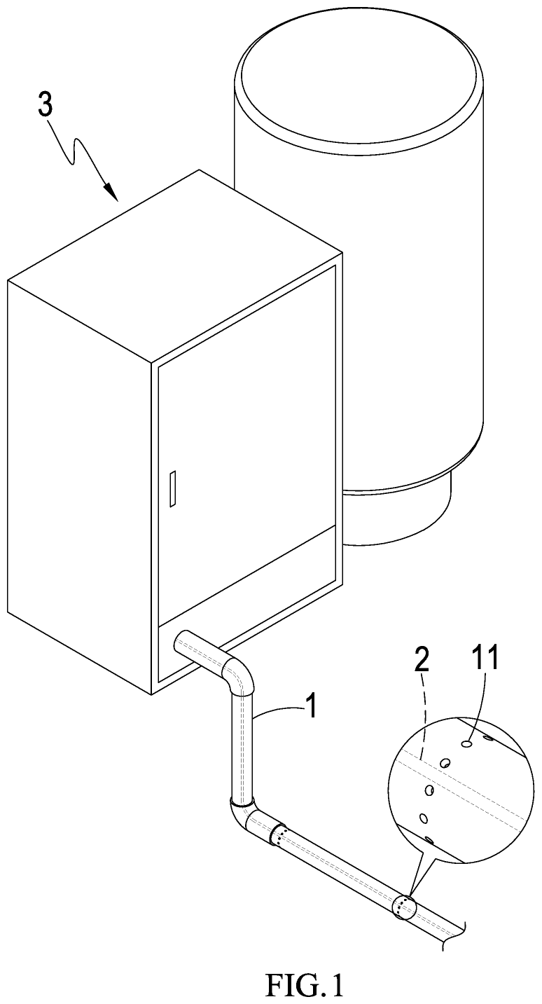

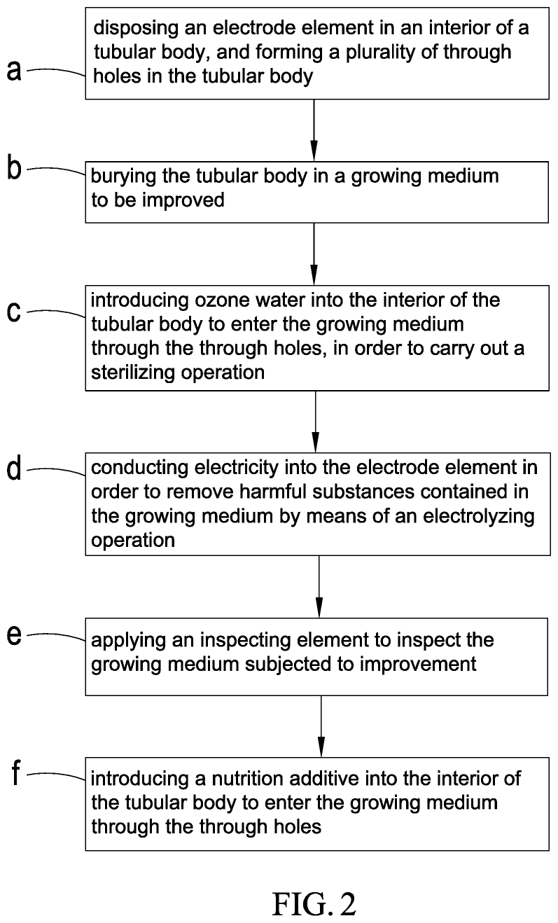

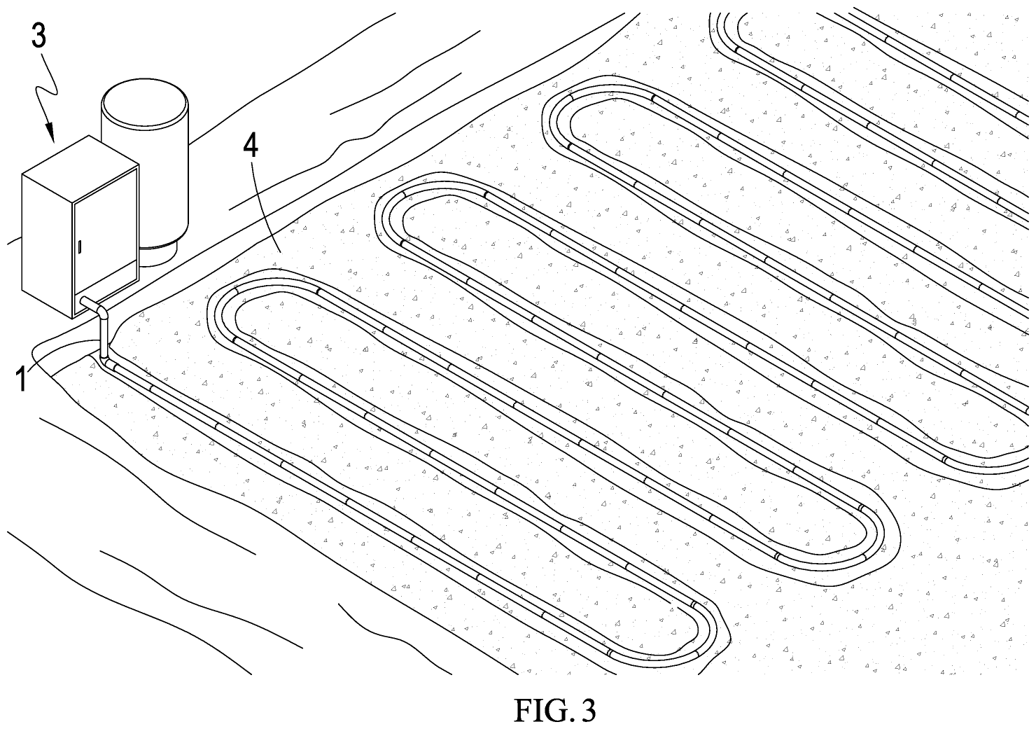

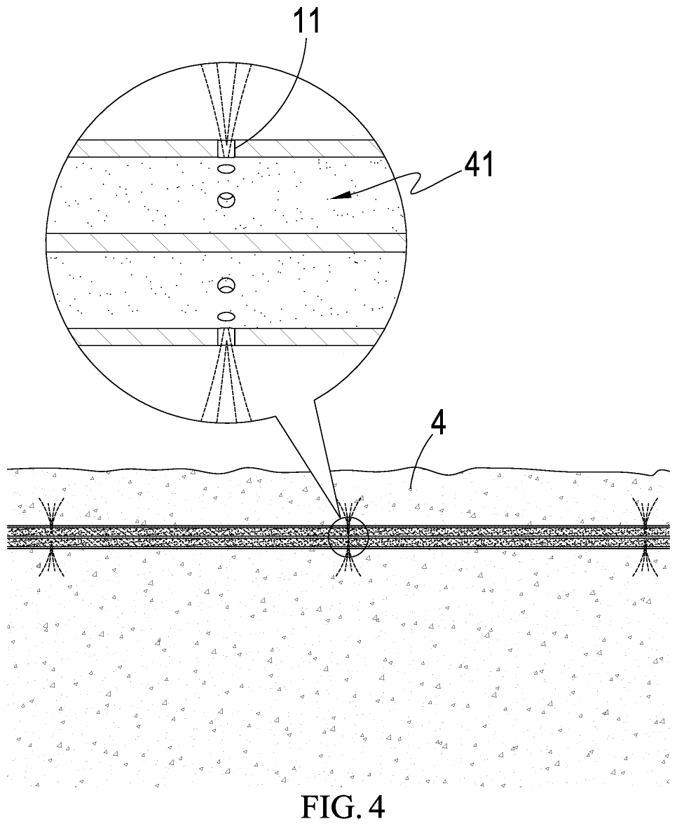

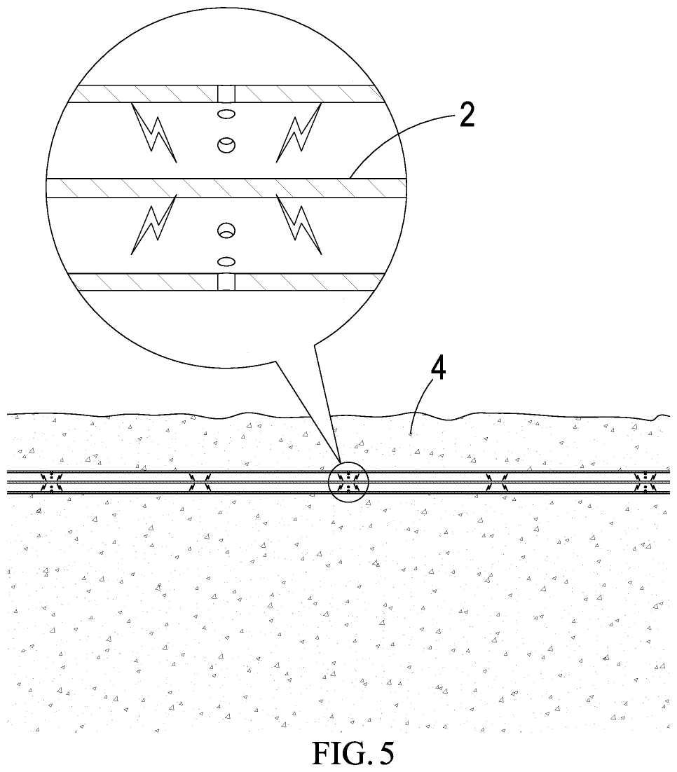

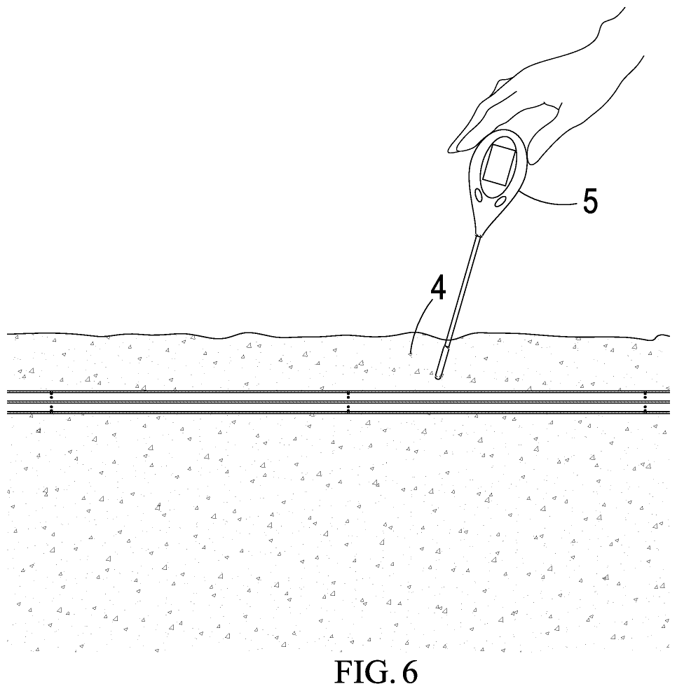

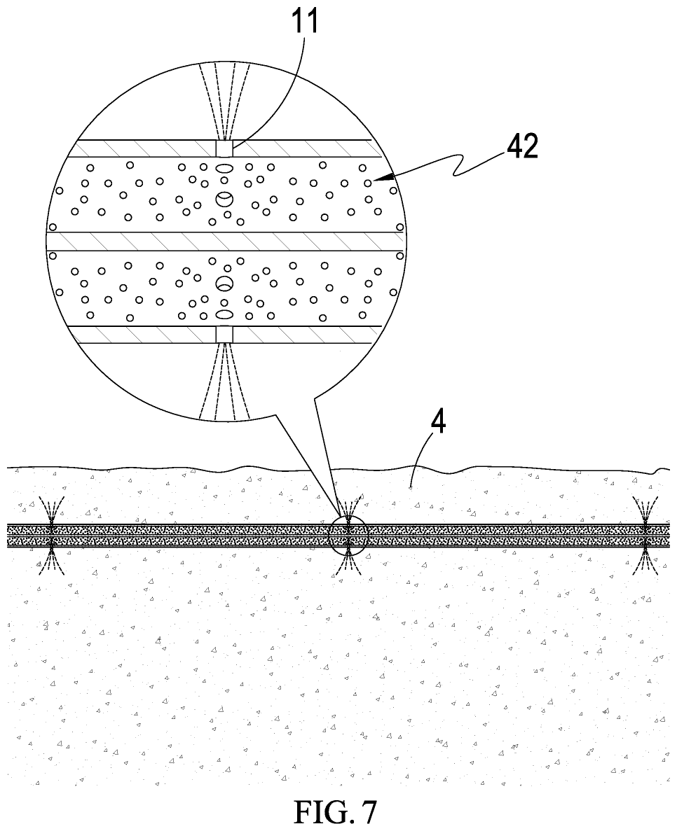

Referring to FIGS. 1-7, which show a perspective view to a schematic view of fertilizing according to a preferred embodiment of the present invention, the drawings clearly show that the present invention comprises:

a tubular body 1, the tubular body 1 being exemplified as a foldable or bendable plastic tube in the instant embodiment, but not limited thereto;

a plurality of through holes 11 formed in the tubular body 1;

an electrode element 2 arranged in an interior of the tubular body 1, a conductive disposed in the tubular body 1 being taken as an example in the instant embodiment, but not limited thereto; and

an improvement-controlling body 3 connected to the tubular body 1 and the electrode element 2.

A soil and water quality improvement method according to the present invention comprises the following steps:

(a) disposing an electrode element in an interior of a tubular body, and forming a plurality of through holes in the tubular body;

(b) burying or installing the tubular body in a growing medium to be improved;

(c) introducing ozone water into the interior of the tubular body to enter and spread into the growing medium through the through holes, in order to carry out a sterilizing operation;

(d) conducting electricity into the electrode element in order to remove harmful substances contained in the growing medium by means of an electrolyzing operation;

(e) applying an inspecting element to inspect the growing medium subjected to improvement; and

(f) introducing a nutrition additive into the interior of the tubular body to enter the growing medium through the through holes.

It can be known from the above description that a user first placing an electrode element 2 in a tubular body 1 that is formed with a plurality of through holes 11 and then burying the tubular body 1 in a growing medium 4 that is to be improved, in such a way that the tubular body 1 is distributed and arranged uniformly in the growing medium 4, wherein the growing medium 4 is one of soil or liquid water, and soil is taken as an example in the instant embodiment, and thus, after the burying operation, the user may control or operate an improvement-controlling body 3 to carry out subsequent operations, wherein the improvement-controlling body 3 first introduce ozone water 41 into the interior of the tubular body 1, and the improvement-controlling body 3 can be an electronic controlling body that controls a flow rate of the ozone water 41 by electronic control measure, and the through holes 11 allow the ozone water 41 to penetrate and enter the soil to carry out operations of sterilizing the soil and removing heavy metals therefrom and, also, in the meantime, carry out an operation of wetting the soil for subsequent performance of an electrolyzing operation, and after the sterilizing operation, the improvement-controlling body 3 is controlled to conduct electricity to the electrode element 2 to carry out an operation of electrolyzing for the soil to remove harmful substances and pests from the soil to thereby realize a complete effect of purification and cleaning, and after the operation of electrolyzing, an inspecting element 5 can be penetrated into the soil to inspect and identify the condition of the soil in order to get aware of the state of improvement and acidity and alkalinity or pH value of the soil, and after the identification, the improvement-controlling body 3 is operated to add or introduce a nutrition additive 42 that is necessary for cultivation of agricultural crops or plants into the tubular body 1, and the improvement-controlling body 3 is operable to control, through electronic control, a flow rate of the nutrition additive 42, wherein in the instant embodiment, the nutrition additive 42 is one of an organic fertilizer and an inorganic fertilizer, but not limited thereto, and alternatively, other nutrition additive 42 that helps improve the condition of soil may be applied, and as such, complete improvement or modification of a contaminated growing medium 4 is realized to thereby enable reuse of the growing medium 4, such as growing agricultural plants, and in use, it only needs to bury the tubular body 1 to achieve the effect of improvement and cleaning, making the use easy and convenient.

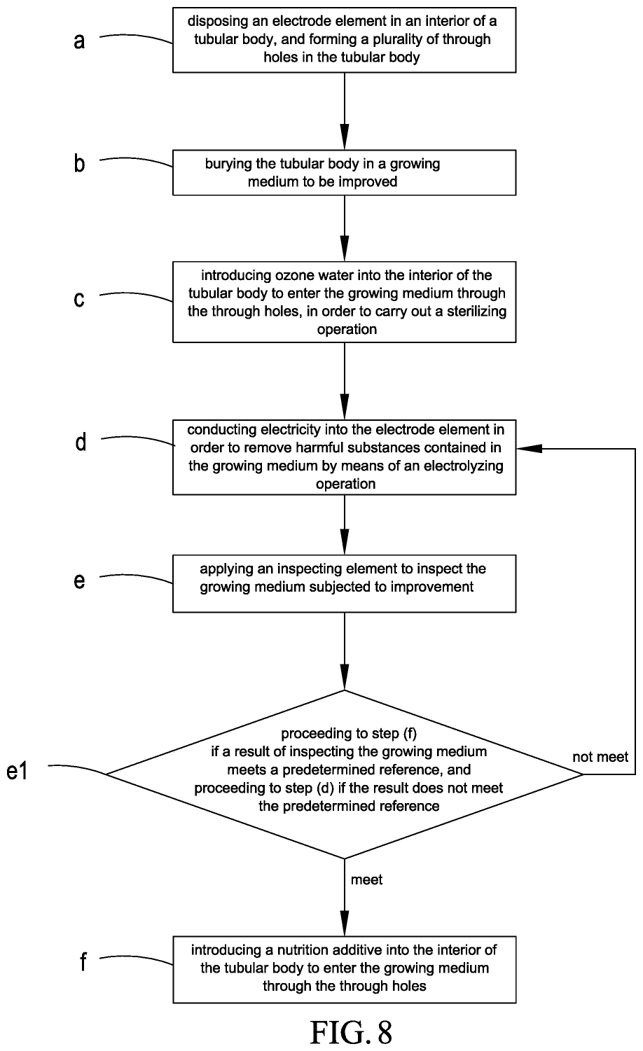

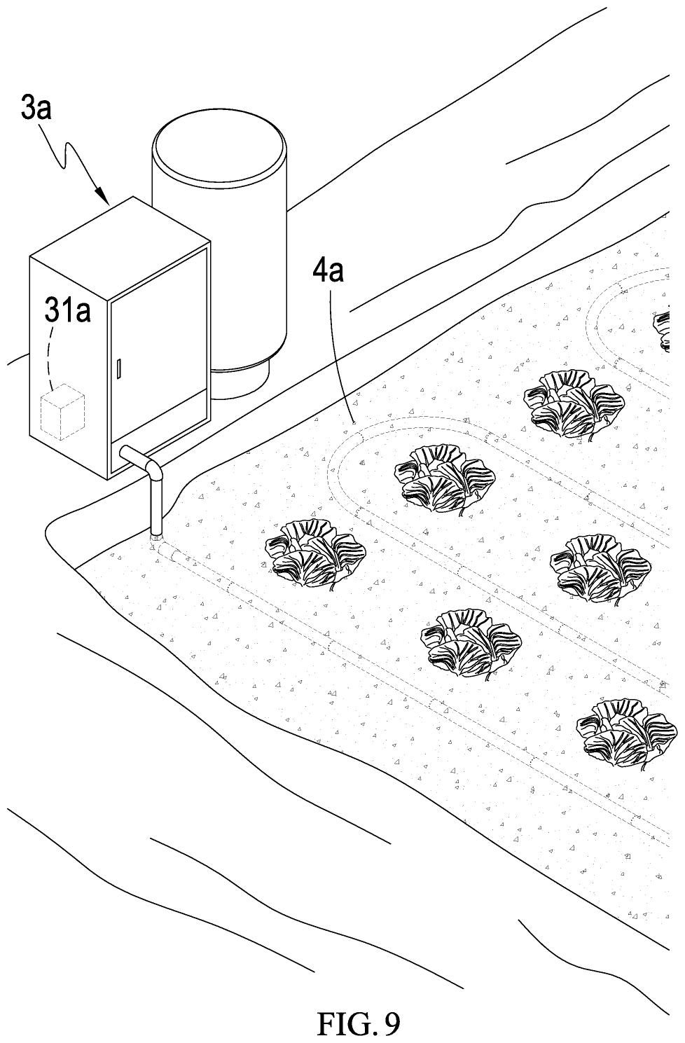

Further referring to FIGS. 8 and 9, which are a flow chart illustrating steps of a process according to another preferred embodiment of the present invention and a schematic view showing timed electrolyzing of the embodiment, it can be clearly seen from the drawings, the instant embodiment is generally similar to the previous embodiment, and in the instant embodiment, an improvement-controlling body 3a is provided therein with a timing device 31a, and the instant embodiment comprises the following steps:

(a) disposing an electrode element in an interior of a tubular body, and forming a plurality of through holes in the tubular body;

(b) burying or installing the tubular body in a growing medium to be improved;

(c) introducing ozone water into the interior of the tubular body to enter and spread into the growing medium through the through holes, in order to carry out a sterilizing operation;

(d) conducting electricity into the electrode element in order to remove harmful substances contained in the growing medium by means of an electrolyzing operation;

(e) applying an inspecting element to inspect the growing medium subjected to improvement;

(e1) proceeding to step (f) if a result of inspecting the growing medium achieves a predetermined reference, and proceeding to step (d) if the result does not achieve the predetermined reference; and

(f) introducing a nutrition additive into the interior of the tubular body to enter the growing medium through the through holes.

It can be known from the above description that in the instant embodiment, step (e1) can be carried out after step (e), and this implies that after the first round of electrolyzing operation and inspecting operation, if the growing medium 4a does not meet the predetermined reference, another round of electrolyzing operation can be carried out and thus, through repeated performance of electrolyzing, a result of complete improvement may be realized.

After plantation of agricultural plants, the timing device 31a may be put into operation to allow the improvement-controlling body 3a to carry out an electrolyzing operation at a predetermined time point, so that removal of harmful substances and killing of pests in the growing medium 4a in a scheduled manner, to thereby improve an overall effect of improvement, making the agricultural plants growing in a healthier way.

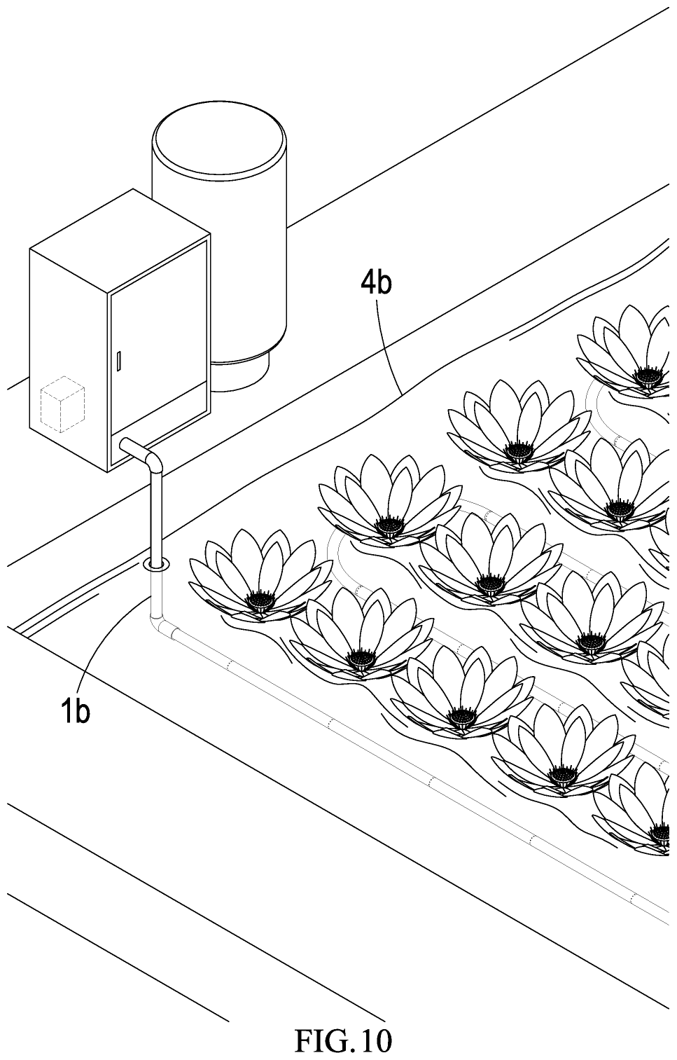

Further referring to FIG. 10, which is a schematic view showing planting according to a further embodiment of the present invention, it can be clearly seen from the drawing, the instant embodiment is generally similar to the previous embodiments, and in the instant embodiment, liquid water is used as an example of the growing medium 4b, so that the tubular body 1b is disposed under the liquid water in order to improve quality of the liquid water, allowing a user to grow aquatic plants in or above the liquid water.

The above description is provided for illustrating preferred embodiments of the present invention and is not intended to constrain the scope of the appended claims. Easy modification and equivalent variation available from the contents of the disclosure and the drawings are considered belonging to the scope of the present invention as defined in the appended claims.

I claim:

1. A soil and water quality improvement method, comprising the following steps:
(a) disposing an electrode element in an interior of a tubular body, and forming a plurality of through holes in the tubular body;
(b) burying or installing the tubular body in a growing medium to be improved, the growing medium being one of soil or liquid water;
(c) introducing ozone water into the interior of the tubular body to enter and spread into the growing medium through the through holes, in order to carry out a sterilizing operation;
(d) conducting electricity into the electrode element in order to remove harmful substances contained in the growing medium by means of an electrolyzing operation;
(e) applying an inspecting element to inspect the growing medium subjected to improvement; and
(f) introducing a nutrition additive into the interior of the tubular body to enter the growing medium through the through holes.

2. The soil and water quality improvement method according to claim 1, wherein the nutrition additive comprises one of an organic fertilizer and an inorganic fertilizer.

3. The soil and water quality improvement method according to claim 1, wherein after step (e), step (e1) is executed to proceed to step (f) if a result of inspecting the growing medium meets a predetermined reference, or to proceed to step (d) if the result does not meet the predetermined reference.

4. The soil and water quality improvement method according to claim 1, wherein the tubular body and the electrode element are connected to an improvement-controlling body.

5. The soil and water quality improvement method according to claim 4, wherein the improvement-controlling body is operable to control amount and timing of introducing the ozone water and the nutrition additive and also to control an electrical power conducted to the electrode element.

6. The soil and water quality improvement method according to claim 4, wherein the improvement-controlling body is provided therein with a timing device.
